(19) United States
(12) Patent Application Publication
(10) Pub. No.: US 2023/0388815 A1
(43) Pub. Date: Nov. 30, 2023

(54) DIRECTIONAL SENSING IN CELLULAR SYSTEMS

(71) Applicant: Samsung Electronics Co., Ltd., Suwon-si (KR)

(72) Inventors: Jeongho Jeon, San Jose, CA (US); Gilwon Lee, McKinney, TX (US); Caleb K. Lo, San Jose, CA (US); Joonyoung Cho, Portland, OR (US); Jianzhong Zhang, Dallas, TX (US)

(21) Appl. No.: 18/194,424

(22) Filed: Mar. 31, 2023

Related U.S. Application Data
(60) Provisional application No. 63/346,049, filed on May 26, 2022.
(60) Provisional application No. 63/350,715, filed on Jun. 9, 2022.

(51) Int. Cl. H04W 16/28; H04B 7/06; H04B 17/336

(52) U.S. Cl. CPC H04W 16/28; H04B 7/0617; H04B 17/336

(57) ABSTRACT

Directional sensing capability, including number of beams, beam-width, analog or digital beam sweeping, and supported waveforms, may be indicated by a user equipment (UE), which may then receive a configuration for directional sensing including number of beams, maximum or minimum beam-width, reception time between transmission beam sweeping, and waveform. The UE then performs directional sensing based on the received configuration. The configuration for directional sensing may be for one of monostatic sensing with reception periods between consecutive sensing signal transmissions or bistatic sensing using a plurality of beams. The UE's directional sensing capability may include capability of spatial multiplexing of sensing signals with communication signals. The configuration for directional sensing may permit spatial multiplexing of sensing signals with communication signals. The UE may determine to perform spatial multiplexing of sensing signals with communication signals based on orthogonality of a desired sensing beam with a beam for communications.

### CROSS-REFERENCE TO RELATED APPLICATION AND CLAIM OF PRIORITY

This application claims priority under 35 U.S.C. § 119(e) to U.S. Provisional Patent Application No. 63/346,049 filed May 26, 2022 and U.S. Provisional Patent Application No. 63/350,715 filed Jun. 9, 2022. The content of the above-identified patent document(s) is incorporated herein by reference.

### TECHNICAL FIELD

The present disclosure relates generally to sensing in cellular communication systems, and more specifically to directional sensing and interference suppression.

### BACKGROUND

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 giga-Hertz (GHz) or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

### SUMMARY

Directional sensing capability, including number of beams, beam-width, analog or digital beam sweeping, and supported waveforms, may be indicated by a user equipment (UE), which may then receive a configuration for directional sensing including number of beams, maximum or minimum beam-width, reception time between transmission beam sweeping, and waveform. The UE then performs directional sensing based on the received configuration. The configuration for directional sensing may be for one of monostatic sensing with reception periods between consecutive sensing signal transmissions or bistatic sensing using a plurality of beams. The UE's directional sensing capability may include capability of spatial multiplexing of sensing signals with communication signals. The configuration for directional sensing may permit spatial multiplexing of sensing signals with communication signals. The UE may determine to perform spatial multiplexing of sensing signals with communication signals based on orthogonality of a desired sensing beam with a beam for communications.

In a first embodiment, a method includes indicating, by a UE, the UE's directional sensing capability including number of beams, beam-width, analog or digital beam sweeping, and supported waveforms. The method also includes receiving, at the UE, a configuration for directional sensing including number of beams, maximum or minimum beam-width, reception time between transmission beam sweeping, and waveform. The method further includes performing, by the UE, directional sensing based on the received configuration.

In a second embodiment, a UE includes a transceiver configured to indicate the UE's directional sensing capability including number of beams, beam-width, analog or digital beam sweeping, and supported waveforms, and to receive a configuration for directional sensing including number of beams, maximum or minimum beam-width, reception time between transmission beam sweeping, and waveform. The UE also includes a processor operably coupled to the transceiver and configured to perform directional sensing based on the received configuration.

In a third embodiment, a base station (BS) includes a transceiver configured to receive, from a UE, an indication of the UE's directional sensing capability including number of beams, beam-width, analog or digital beam sweeping, and supported waveforms, and to transmit a configuration for directional sensing including number of beams, maximum or minimum beam-width, reception time between transmission beam sweeping, and waveform. Directional sensing is performed based on the received configuration.

In any of the preceding embodiments, the configuration for directional sensing may be for one of monostatic sensing with reception periods between consecutive sensing signal transmissions or bistatic sensing using a plurality of beams.

In any of the preceding embodiments, the UE's directional sensing capability may include capability of spatial multiplexing of sensing signals with communication signals. The configuration for directional sensing may permit spatial multiplexing of sensing signals with communication signals. The UE may determine to perform spatial multiplexing of sensing signals with communication signals based on orthogonality of a desired sensing beam with a beam for communications.

In any of the preceding embodiments, the UE may exchange, with a BS, information on a sensing signal waveform, sensing signal beamforming vector, and channel state information on an interference channel for use by the BS in performing sensing signal interference cancelation with uplink data communications signals from another UE.

In any of the preceding embodiments, the UE may receive an indication of overlap of resources for downlink data reception by the UE and resources for directional sensing by another UE. The UE may receive information relating to sensing signal waveform and beamforming vector used by the other UE. An interference channel between the UE and the other UE may be measured, and downlink data may be received after performing interference cancelation based on the measured interference channel.

In any of the preceding embodiments, the configuration for directional sensing may indicate a restricted beam, where a restriction on the restricted beam may comprises one of use of the restricted beam for sensing, maximum sensing transmission power, or target sensing reception power. The restriction may correspond to one of a time pattern, frequency resources, or a trigger for the restriction. The restriction may be based on operations of another UE.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Likewise, the term “set” means one or more. Accordingly, a set of items can be a single item or a collection of two or more items.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an exemplary networked system to support directional sensing and interference suppression according to various embodiments of this disclosure;

FIG. 2 illustrates an exemplary base station (BS) to support directional sensing and interference suppression according to various embodiments of this disclosure;

FIG. 3 illustrates an exemplary electronic device for communicating in the networked computing system supporting directional sensing and interference suppression according to various embodiments of this disclosure;

FIG. 4 illustrates a high level diagram of a monostatic radar according to various embodiments of this disclosure;

FIGS. 5A and 5B illustrate high level diagrams of a bi-static radar according to various embodiments of this disclosure;

FIG. 6 illustrates a high level diagram of a JCS implementation according to various embodiments of this disclosure;

FIG. 7 illustrates a high level diagram of JCS signal flow according to various embodiments of this disclosure;

FIG. 8 illustrates a high level flowchart for UE operation of sensing configuration according to various embodiments of this disclosure;

FIG. 9 illustrates a high level flowchart for NW operation of sensing configuration according to various embodiments of this disclosure;

FIG. 10 illustrates an example timing diagram for monostatic sensing according to various embodiments of this disclosure;

FIG. 11 illustrates a high level diagram of an example directional sensing via beam sweeping according to various embodiments of this disclosure;

FIG. 12 illustrates a high level flowchart for UE operation of directional sensing according to various embodiments of this disclosure;

FIG. 13 illustrates a high level flowchart for NW operation of directional sensing according to various embodiments of this disclosure;

FIG. 14 illustrates an example of monostatic directional sensing operation according to various embodiments of this disclosure;

FIG. 15 illustrates an example of bi-static directional sensing operation from transmitter perspective according to various embodiments of this disclosure;

FIG. 16 illustrates an example of spatial multiplexing of communication and sensing signal according to various embodiments of this disclosure;

FIG. 17 illustrates a high level flowchart for UE operation of spatial multiplexing of communication and sensing signal according to various embodiments of this disclosure;

FIG. 18 illustrates a high level flowchart for NW operation of spatial multiplexing of communication and sensing signal according to various embodiments of this disclosure;

FIG. 19 illustrates an example of sensing interference at a BS for UL data demodulation according to various embodiments of this disclosure;

FIG. 20 illustrates a high level diagram of an example procedure for sensing interference cancelation at a BS for UL data demodulation according to various embodiments of this disclosure;

FIG. 21 illustrates a high level flowchart for a NW to perform sensing interference cancelation for UL data reception according to various embodiments of this disclosure;

FIG. 22 illustrates a high level flowchart for a UE performing sensing and assisting NW for sensing interference cancelation according to various embodiments of this disclosure;

FIG. 23 illustrates an example of sensing interference at a UE for DL data demodulation according to various embodiments of this disclosure;

FIG. 24 illustrates a high level diagram of an example procedure for sensing interference cancelation at a UE for DL data demodulation according to various embodiments of this disclosure;

FIG. 25 illustrates an example of a NW to assist sensing interference cancelation at a UE for DL data reception according to various embodiments of this disclosure;

FIG. 26 illustrates an example of a UE receiving DL data with sensing interference cancelation according to various embodiments of this disclosure;

FIGS. 27A and 27B illustrate examples of sensing beam restriction according to various embodiments of this disclosure;

FIG. 28 illustrates an example of a UE receiving DL data with sensing interference cancelation according to various embodiments of this disclosure; and

FIG. 29 illustrates an example for NW to configure sensing beam restriction to a UE transmitting sensing signal according to various embodiments of this disclosure.

### DETAILED DESCRIPTION

The figures included herein, and the various embodiments used to describe the principles of the present disclosure are by way of illustration only and should not be construed in any way to limit the scope of the disclosure. Further, those skilled in the art will understand that the principles of the present disclosure may be implemented in any suitably arranged wireless communication system.

### REFERENCES

[1] 3GPP TS 38.211 Rel-16 v16.4.0, “NR; Physical channels and modulation,” Dec. 2020.
[2] 3GPP TS 38.212 Rel-16 v16.4.0, “NR; Multiplexing and channel coding,” Dec. 2020.
[3] 3GPP TS 38.213 Rel-16 v16.4.0, “NR; Physical layer procedures for control,” Dec. 2020.
[4] 3GPP TS 38.214 Rel-16 v16.4.0, “NR; Physical layer procedures for data,” Dec. 2020.
[5] 3GPP TS 38.321 Rel-16 v16.3.0, “NR; Medium Access Control (MAC) protocol specification,” Dec. 2020.
[6] 3GPP TS 38.331 Rel-16 v16.3.0, “NR; Radio Resource Control (RRC) protocol specification,” Dec. 2020.
[7] 3GPP TS 38.300 Rel-16 v16.4.0, “NR; NR and NG-RAN Overall Description; Stage 2,” Dec. 2020.
   The above-identified references are incorporated herein by reference.

### ABBREVIATIONS

3GPP Third generation partnership project
ACK Acknowledgement
AP Antenna port
BCCH Broadcast control channel
BCH Broadcast channel
BD Blind decoding
BFR Beam failure recovery
BI Back-off indicator
BW Bandwidth
BLER Block error ratio
BL/CE Bandwidth limited, coverage enhanced
BWP Bandwidth Part
CA Carrier aggregation
CB Contention based
CBG Code block group
CBRA Contention based random access
CBS PUR Contention based shared PUR
CCE Control Channel Element
CD-SSB Cell-defining SSB
CE Coverage enhancement
CFRA Contention free random access
CFS PUR Contention free shared PUR
CG Configured grant
CGI Cell global identifier
CI Cancelation indication
CORESET Control Resource Set
CP Cyclic prefix
C-RNTI Cell RNTI
CRB Common resource block
CR-ID Contention resolution identity
CRC Cyclic Redundancy Check
CSI Channel State Information
CSI-RS Channel State Information Reference Signal
CS-G-RNRI Configured scheduling group RNTI
CS-RNTI Configured scheduling RNTI
CSS Common search space
DAI Downlink assignment index
DCI Downlink Control Information
DFI Downlink Feedback Information
DL Downlink
DMRS Demodulation Reference Signal
DTE Downlink transmission entity
EIRP Effective isotropic radiated power
eMTC enhanced machine type communication
EPRE Energy per resource element
FDD Frequency Division Duplexing
FDM Frequency division multiplexing
FDRA Frequency domain resource allocation
FR1 Frequency range 1
FR2 Frequency range 2
gNB gNodeB
GPS Global positioning system
HARQ Hybrid automatic repeat request
HARQ-ACK Hybrid automatic repeat request acknowledgement
HARQ-NACK Hybrid automatic repeat request negative acknowledgement
HPN HARQ process number
ID Identity
IE Information element
IIoT Industrial internet of things
IoT Internet of Things
JCS Joint Communication and Sensing
KPI Key performance indicator
LB T Listen before talk
LNA Low-noise amplifier
LRR Link recovery request
LSB Least significant bit
LTE Long Term Evolution
MAC Medium access control
MAC-CE MAC control element
MCG Master cell group
MCS Modulation and coding scheme
MIB Master Information Block
MIMO Multiple input multiple output
MPE maximum permissible exposure
MTC Machine type communication
mMTC massive machine type communication
MSB Most significant bit
NACK Negative acknowledgment
NDI New data indicator
NPN Non-public network
NR New Radio
NR-L NR Light/NR Lite
NR-U NR unlicensed
NTN Non-terrestrial network
NW Network
OSI Other system information
PA Power amplifier
PI Preemption indication
PBCH Physical broadcast channel
PCell Primary cell
PRACH Physical Random Access Channel
PDCCH Physical Downlink Control Channel
PDSCH Physical Downlink Shared Channel
PUCCH Physical Uplink Control Channel
PUSCH Physical Uplink Shared Channel
PMI Precoder matrix indicator
P-MPR Power Management Maximum Power Reduction
PO PUSCH occasion
PSCell Primary secondary cell
PSS Primary synchronization signal
P-RNTI Paging RNTI
PRG Precoding resource block group
PRS Positioning reference signal
PTRS Phase tracking reference signal
PUR Pre-configured uplink resource
QCL Quasi co-located/Quasi co-location
RA Random access
RACH Random access channel
RAPID Random access preamble identity
RAR Random access response
RA-RNTI Random access RNTI
RAN Radio Access Network
RAT Radio access technology
RB Resource Block
RBG Resource Block group
RF Radio Frequency
RLF Radio link failure
RLM Radio link monitoring
RMSI Remaining minimum system information
RNTI Radio Network Temporary Identifier
RO RACH occasion
RRC Radio Resource Control
RS Reference Signal
RSRP Reference signal received power
RV Redundancy version
Rx Receive/Receiving
SAR Specific absorption rate
SCG Secondary cell group
SFI Slot format indication
SFN System frame number
SI System Information
SIC Successive Interference Cancelation
SI-RNTI System Information RNTI
SIB System Information Block
SINR Signal to Interference and Noise Ratio
SCS Sub-carrier spacing
SMPTx Simultaneous multi-panel transmission
SMPTRx Simultaneous multi-panel transmission and reception
SpCell Special cell
SPS Semi-persistent scheduling
SR Scheduling Request
SRI SRS resource indicator
SRS Sounding reference signal
SS Synchronization signal
SSB SS/PBCH block
SSS Secondary synchronization signal
STxMP Simultaneous transmission by multiple panels
STRxMP Simultaneous transmission and reception by multiple panels
TA Timing advance
TB Transport Block
TBS Transport Block size
TCI Transmission Configuration Indication
TC-RNTI Temporary cell RNTI
TDD Time Division Duplexing
TDM Time division multiplexing
TDRA Time domain resource allocation
TPC Transmit Power Control
TRP Total radiated power
Tx Transmit/Transmitting
UCI Uplink Control Information
UE User Equipment
UL Uplink
UL-SCH Uplink shared channel
URLLC Ultra reliable and low latency communication
UTE Uplink transmission entity
V2X Vehicle to anything
VoIP Voice over Internet Protocol (IP)
XR eXtended reality

The present disclosure relates to beyond 5G or 6G communication system to be provided for supporting one or more of: higher data rates, lower latency, higher reliability, improved coverage, and massive connectivity, and so on. Various embodiments apply to UEs operating with other RATs and/or standards, such as different releases/generations of 3GPP standards (including beyond 5G, 6G, and so on), IEEE standards (such as 802.11/15/16), and so forth.

This disclosure pertains joint communication and radar sensing, wherein a UE is able to perform downlink/uplink/sidelink communication and also perform radar sensing by “sensing”/detecting environmental objects and their physical characteristics such as location/range, velocity/speed, elevation, angle, and so on. Radar sensing is achieved by sending a suitable sounding waveform and receiving and analyzing reflections or echoes of the sounding waveform. Such radar sensing operation can be used for applications and use-case such as proximity sensing, liveness detection, gesture control, face recognition, room/environment sensing, motion/presence detection, depth sensing, and so on, for various UE form factors. For some larger UE form factors, such as (driver-less) vehicles, trains, drones and so on, radar sensing can be additionally used for speed/cruise control, lane/elevation change, rear/blind spot view, parking assistance, and so on. Such radar sensing operation can be performed in various frequency bands, including mmWave/FR2 bands. In addition, with THz spectrum, ultra-high resolution sensing, such as sub-cm level resolution, and sensitive Doppler detection, such as micro-Doppler detection, can be achieved with very large bandwidth allocation, for example, on the order of several GHz or more.

Current implementations can support individual operation of communication and sensing, wherein the UE is equipped with separate modules, in terms of baseband processing units and/or RF chain and antenna arrays, for communication procedures and radar procedures. The separate communication and sensing architectures require repetitive implementation that increases UE complexity. In addition, since the two modules are designed separately, there is little/no coordination between the modules, so time/frequency/sequence/spatial resources are not efficiently used by the two modules, which in some cases can even lead to (self-)interference between the two modules of a same UE. In addition, the radar sensing operation of the UE can be based on pure implementation-based methods and without any unified standards support, which can cause (significant) inter-UE issues, or may not be fully compatible with cellular systems. Furthermore, separate design of the two modules makes it difficult to use measurement or information acquired by one module to assist the other module. For example, the communication module may be unaware of a potential beam blockage due to a nearby object, although the sensing module may have already detected the object.

There is a need to develop a unified standard for support of joint communication and sensing to reduce the UE implementation complexity and enable coexistence of the two modules. There is another need to ensure time/frequency/sequence/spatial resources are efficiently used across communication and sensing modules of a same UE, as well as among different UEs performing these two operations, to reduce/avoid (self-)interference. There is a further need to design the two operations in such a way to provide assistance to each other by exchanging measurement results and acquired information, so that both procedures can operate more robustly and effectively.

The present disclosure provides designs for the support of joint communication and radar sensing. In particular, this disclosure is regarding directional sensing and interference suppression for joint communication and sensing in user equipments.

Embodiments of the disclosure for supporting joint communication and radar sensing in wireless communication systems are summarized in the following and are fully elaborated further below.
Method and apparatus for directional sensing for directional object detection.
Method and apparatus for spatial multiplexing of communication and sensing signals.

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

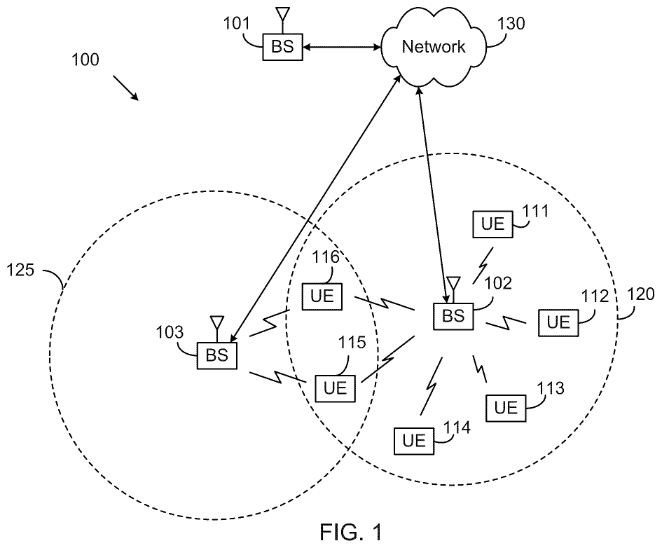

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an exemplary networked system utilizing directional sensing in a cellular system according to various embodiments of this disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

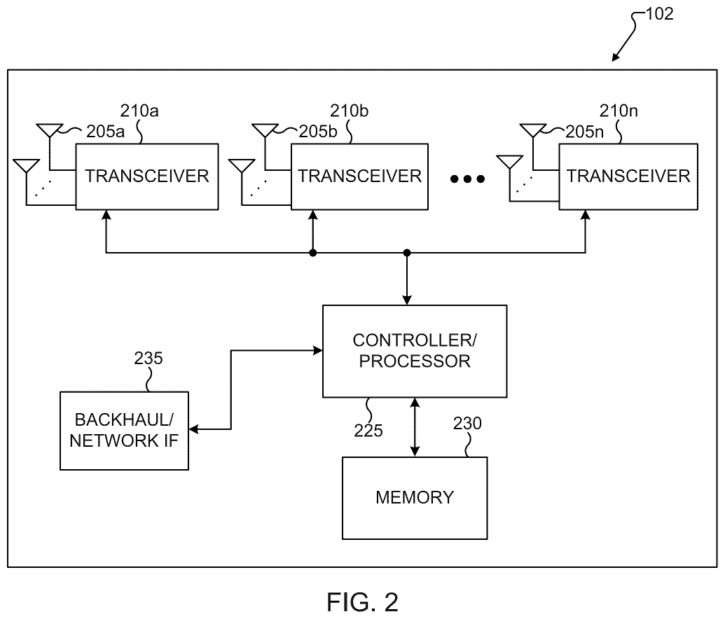

FIG. 2 illustrates an exemplary base station (BS) utilizing directional sensing in a cellular system according to various embodiments of this disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

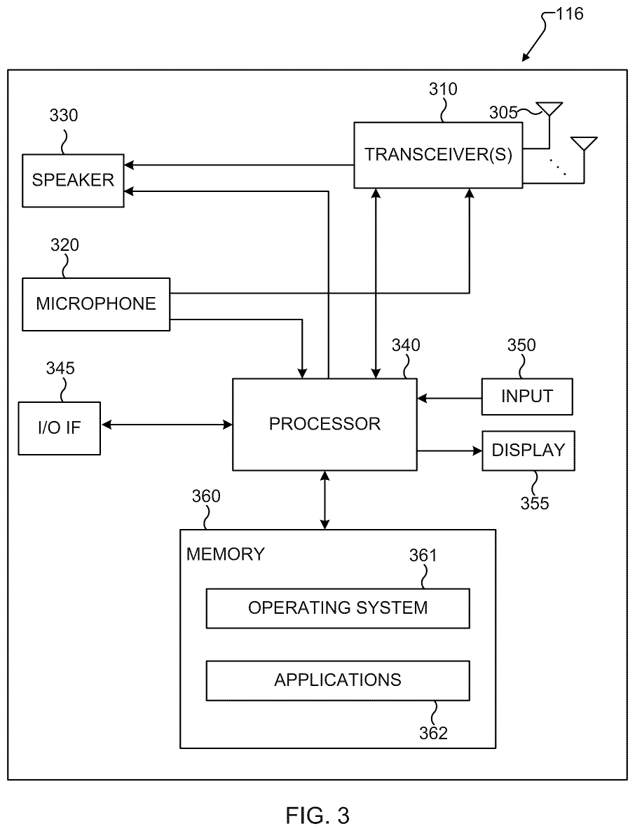

FIG. 3 illustrates an exemplary electronic device for communicating in the networked computing system utilizing directional sensing in a cellular system according to various embodiments of this disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

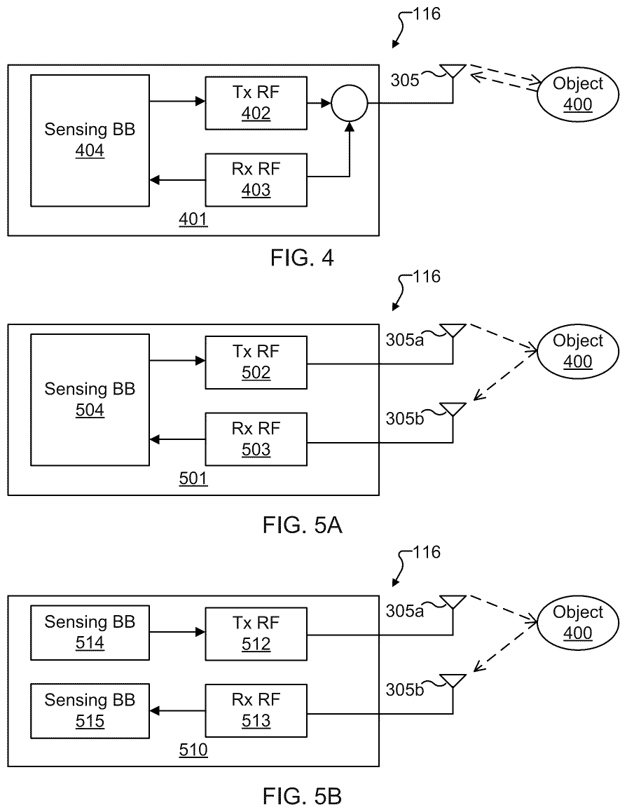

FIG. 4 illustrates a high level diagram of a monostatic radar according to various embodiments of this disclosure. The embodiment of FIG. 4 is for illustration only. Other embodiments of the system 401 could be used without departing from the scope of this disclosure.

FIG. 4 illustrates a monostatic radar system in which the transmission of radar waveform and the reception of reflected waveform alternates and is performed within a device 116. Monostatic radar system 401 includes transmit RF processing 402 and receive RF processing 403 coupled to the same antenna 305, and respectively receiving output from and providing input to a single baseband (BB) processing circuit 404. Signals provided by transmit RF processing 402 are transmitted using the antenna 305, reflect off the object 400 and are received by antenna 305, and are filtered and otherwise pre-processed by receive RF processing 403 for use by sensing baseband processing circuit 404 in determining distance, velocity, acceleration, and/or direction of the object 400. Monostatic radar is suitable for short pulse sensing waveform. To avoid self-interference, the radio needs to turn around from transmission to reception before the reflected signal arrives.

FIGS. 5A and 5B illustrate high level diagrams of a bi-static radar according to various embodiments of this disclosure. The embodiments of FIGS. 5A-5B are for illustration only. Other embodiments of the systems 501, 510 could be used without departing from the scope of this disclosure.

FIGS. 5A and 5B illustrate bi-static radar systems in which the transmission of radar waveform and the reception of reflected waveform can be performed concurrently within a device 116. In each of FIGS. 5A and 5B, radar system 501, 510 includes respective transmit RF processing 502, 512 and respective receive RF processing 503, 513 coupled to different antenna 305a, 305b. In both FIG. 5A and FIG. 5B, signals provided by transmit RF processing 502, 512 are transmitted using one antenna 305a, reflect off the object 400 and are received by another antenna 305b, and are filtered and otherwise pre-processed by receive RF processing 503, 513. However, transmit RF processing 502 and receive RF processing 503 in FIG. 5A still respectively receive output from and provide input to a single baseband processing circuit 504. By contrast, transmit RF processing 512 receives output from one baseband processing circuit 514 in FIG. 5B, and receive RF processing 513 provides input to a separate baseband processing circuit 515.

Bi-static radar is suitable for continuous transmission of sensing waveform. Both transmission and reception modules can be placed within a device as shown in FIGS. 5A and 5B. In these cases, a separation between transmission and reception antennas is desired. In other embodiments of a bi-static radar system, transmission and reception modules are placed in different devices. A separation between transmission and reception antennas is naturally achieved.

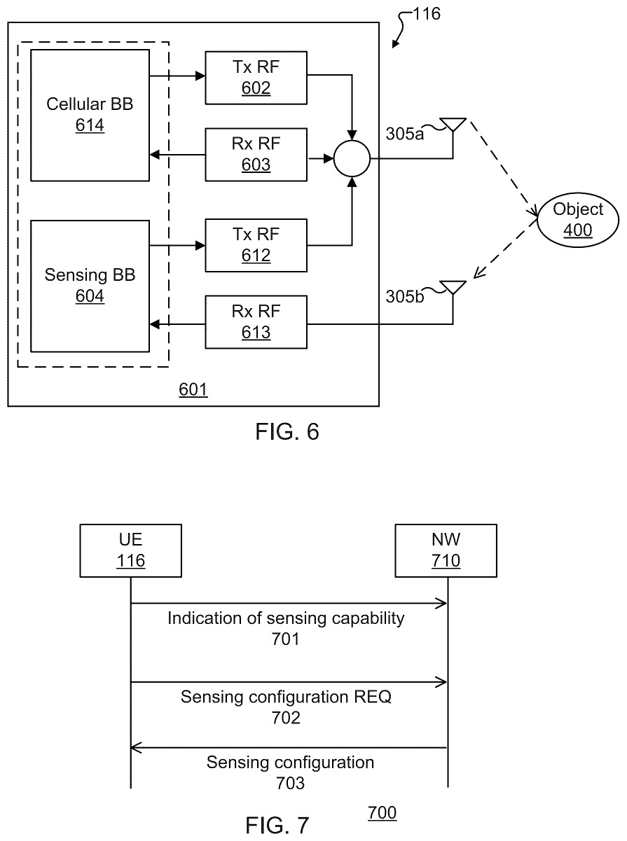

FIG. 6 illustrates a high level diagram of a JCS implementation according to various embodiments of this disclosure. The embodiment of FIG. 6 is for illustration only. Other embodiments of the system 601 could be used without departing from the scope of this disclosure.

FIG. 6 illustrates a possible JCS UE implementation for UEs having cellular communication modules. JCS system 601 includes transmit RF processing 602 and receive RF processing 603 coupled to one antenna 305a, and respectively receiving output from and providing input to a cellular baseband processing circuit 614. JCS system 601 also includes transmit RF processing 612 coupled to the first antenna 305a, and receive RF processing 603 coupled to a second antenna 305b. Transmit RF processing 612 and receive RF processing 603 respectively receive output from and provide input to a single sensing baseband processing circuit 604.

The cellular baseband processing circuit 614 and the sensing baseband processing circuit 604 may be discrete modules communicating with each other, or may be (as depicted) logically separate but integrated into a single module. In this example, the transmission of sensing waveform and the reception of reflected sensing waveform can be concurrent while transmission/reception for communication are switched off, enabling bi-static radar operation. Also, concurrent transmission for communication and reception for sensing waveform are possible. In that case, the sensing could be monostatic (the UE both transmits and receives sensing waveforms) or bi-static (another UE or device transmits the sensing waveform). Concurrent reception for communication and reception for sensing are also possible. SIC may be applied to remove the interference from sensing signal for the reception of communication signal or vice versa.

FIG. 7 illustrates a high level diagram of JCS signal flow according to various embodiments of this disclosure. The embodiment of FIG. 7 is for illustration only. Other embodiments of signaling could be used without departing from the scope of this disclosure.

FIG. 7 is an example procedure for UE 116 and NW 710 (e.g., BS 102) to exchange messages for sensing configuration. In 701, a UE 116 sends UE Capability Information (e.g., RRC message) to NW 710, informing the NW 710 of the UE's JCS capability including hardware (HW) capability, SIC capability, etc. In 702, the UE 116 sends a sensing configuration request message including sensing application type, range, and sensing periodicity, etc. In 703, the NW 710 configures sensing operations to UE 116 including waveform, resource, sensing transmission power, periodicity, etc.

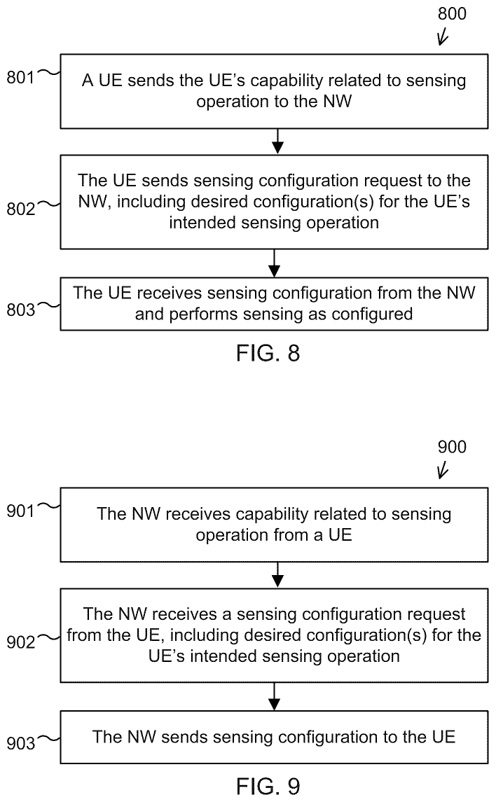

FIG. 8 illustrates a high level flowchart for UE operation of sensing configuration according to various embodiments of this disclosure. The embodiment of FIG. 8 is for illustration only. Other embodiments of the process 800 could be used without departing from the scope of this disclosure.

FIG. 8 is an example of a method 800 for sensing configuration from a UE perspective consistent with FIG. 7. At 801, the UE sends the UE's capability (e.g., in an RRC message) related to sensing operations to the NW, informing the NW of the UE's JCS capability including hardware capability, SIC capability, etc. At 802, the UE sends a sensing configuration request message including desired configuration(s) (sensing application type, range, and sensing periodicity, etc.). At 803, the UE receives sensing configurations from the NW, and then performs sensing as configured.

FIG. 9 illustrates a high level flowchart for NW operation of sensing configuration according to various embodiments of this disclosure. The embodiment of FIG. 9 is for illustration only. Other embodiments of the process 900 could be used without departing from the scope of this disclosure.

FIG. 9 is an example of a method 900 for sensing configuration from a NW perspective, consistent with FIG. 7. At 901, the NW receives the UE's capability (e.g., in an RRC message) related to sensing operations. At 902, the NW receives a sensing configuration request message including desired configuration(s) (sensing application type, range, and sensing periodicity, etc.) for the UE's intended sensing operation. At 903, the NW sends sensing configurations from the NW, and then performs sensing as configured.

In one embodiment, the UE can send its sensing capability to NW. TABLE 1 is an example list of possible information elements (IEs) for UE sensing capability indication to NW:

TABLE 1
Possible IEs for UE sensing capability indication msg

| | Description |
|---|---|
| BB coordination | Coordination between cellular and sensing modem |
| Sensing power | Max Tx power for sensing |
| class | |
| Sensing BW, | Max supported sensing BW; list of supported |
| supported bands, | bands for sensing; indication on whether in- |
| in-band sensing | band sensing is supported or not |
| capability, etc. | |
| RF/Antenna | Shared or separate between cellular and sensing |
| | Shared or separate between sensing Tx and |
| | sensing Rx (monostatic vs. bistatic) |
| Self-interference | Cancelation of cellular Tx signal from sensing Rx |
| cancelation | Cancelation of sensing Tx signal from cellular Rx |
| (full-duplex | |
| capability) | |
| SIC | SIC capability for simultaneous reception of |
| | cellular and sensing signals |
| Waveform | Supported types of sensing waveform |

In one example, the UE can indicate the UE's baseband coordination capability between cellular and sensing modems. Possible indication of values could include {tight coordination, loose coordination, no coordination} as an example. Tight coordination may indicate that the cellular baseband has a full control over sensing baseband or sensing capability is implemented as a function of cellular baseband within an integrated chipset. Loose coordination may indicate that the cellular baseband and sensing baseband can communication on related parameters but one does not have a control over the other. No coordination may indicate that the two baseband functions cannot communicate with each other.

In another example, the UE can indicate the UE's sensing power class to the NW. As an example, the UE can indicate that the UE's sensing power class is the same with the UE's power class for communication or a specific power value, e.g., in decibel-milliwatts (dBm), to the NW, if different.

In yet another example, the UE can indicate the UE's supported sensing bandwidth, e.g., in mega-Hertz (MHz) or giga-Hertz (GHz), so that the NW does not configure a UE for sensing bandwidth exceeding the UE's capability. The UE can also indicate the list of bands that the UE supports for sensing operation. It can be indicated, for instance, in terms of NR band identifier (ID). The UE can also indicate whether in-band sensing can be supported, i.e., operation within a band configured for communication. If in-band sensing is not supported, then by default, the NW can assume that only out-of-band sensing can be supported by the UE.

In yet another example, the UE can indicate whether RF/antennas are shared or separate between cellular and sensing functions. The UE can also indicate whether RF/antennas are shared or separate between sensing transmission and reception. Based on this information, the NW can configure a correct mode of sensing operation, e.g., monostatic or bi-static, and resources for the UE.

In yet another example, the UE can indicate whether the UE has self-interference cancelation capability, e.g., cancelation of cellular transmission signal from sensing reception signal or cancelation of sensing transmission signal from cellular reception signal, etc. The UE can also indicate successive interference cancelation capability between a signal received for communication and a signal received for sensing. The UE can also indicate supported types of sensing waveforms as a part of UE capability indication.

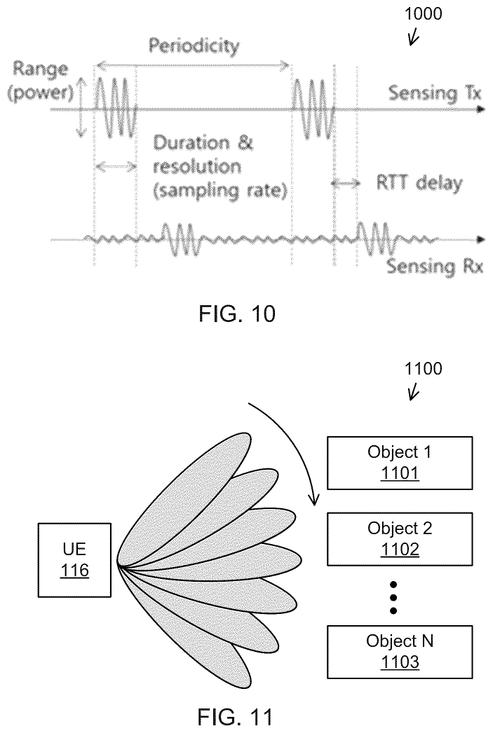

FIG. 10 illustrates an example timing diagram for monostatic sensing according to various embodiments of this disclosure. The embodiment of FIG. 10 is for illustration only. Other embodiments of the timing 1000 could be used without departing from the scope of this disclosure.

FIG. 10 is an example sensing timing diagram for monostatic sensing, i.e., transmission of sensing waveform and the reception of reflected signal occur one at a time due to shared RF/antennas. In this case, the sensing transmission signal duration T_{sensing Tx} should be less than or equal to T_{RTT}−T_{T_Turnaround}, where T_{RTT} is the expected round-trip-time for sensing transmission signal bounce-back considering target sensing application and range and T_{Turnaround} is sensing RF transmission-to-reception turnaround time. If bi-static sensing is supported by UE, no such restriction is required.

In one embodiment, UE sends sensing configuration request message including sensing application type, range, and sensing periodicity, etc. Table. 2 is an example list of possible IEs for UE sensing configuration request message to NW:

TABLE 2
Possible IE for UE sensing configuration request msg

| | Description |
|---|---|
| Application | Automotive, face/gesture recognition, etc. |
| type | |
| Range | Target sensing range, e.g., short/mid/long range sensing |
| Periodicity | Continuous or periodic sensing w/interval |
| Resolution | Required resolution |
| Directional | Beam sweeping for directional sensing, number of |
| sensing | beams, antenna/beamforming gain, 3-dB beam width |
| Sensing | Time duration of sensing Tx signal and reception |
| direction | duration |

In one example, the UE can indicate the UE's sensing application type, such as automotive, face/gesture recognition, etc., as the sensing resource configuration by NW may depend on the requested sensing application type. In another embodiment, the sensing application type may not be directly indicated to the NW but may be indirectly indicated via attributes of required sensing resource configuration.

In another example, the UE can indicate the desired range of sensing operation. As an example, long range sensing may be requested for automotive application or similarly short range sensing may be requested for face/gesture recognition application. The requested range values can be {short, mid, long} with predefined range values for each element. The requested range values can be in terms of meters. The configured sensing transmission power level by NW may depend on this indication.

In yet another example, the UE can indicate the desired periodicity of the sensing, i.e., continuous or periodic sensing with a certain interval. The configured time-domain sensing resource by NW may depend on this indication.

In yet another example, the UE can indicate the desired resolution of the sensing, i.e., fine granularity for sensing. The configured sensing bandwidth by NW may depend on this indication.

In yet another example, the UE can indicate whether directional sensing is requested. In this case, the UE can indicate the desired beamforming gain, 3 decibel (dB) beam width, and the number of beams for sweeping. The UE can obtain object sensing results towards certain directions which can enable various use cases requiring directional sensing information.

In yet another example, the UE can indicate time duration of sensing transmission signal and reception duration. In the case of bi-static sensing, the transmission and reception can be continuous. In the case of monostatic sensing, the transmission duration can be dependent on sensing application type and/or target sensing range, etc.

In another embodiment, the UE can indicate an index from a set of predefined sensing modes (e.g., TABLE 3 below). Each mode is associated with attributes that can support a certain use case including transmission power, bandwidth, range, periodicity, resolution, directional sensing, sensing duration, etc.

TABLE 3
Example of predefined sensing mode

| Mode | Tx Power | BW | (Intended use case) |
|---|---|---|---|
| 1 | 20 dBm | 10 MHZ | Automotive |
| 2 | −1 dBm | 100 MHZ | Face recognition |
| 3 | 0 dBm | 40 MHZ | Gesture recognition |
| 4 | 10 dBm | 20 MHZ | Indoor presence detection |
| . . . | . . . | . . . | . . . |

In one embodiment, the NW configures a UE with sensing resources and attributes and the UE performs sensing according to the configuration. TABLE 4 is an example list of possible IEs for NW sensing configuration message:

TABLE 4
Possible IE for NW sensing configuration msg

| | Description |
|---|---|
| Max Tx power | Max sensing Tx power, i.e., P_{CMAX} |
| Target reception | For sensing Tx power control based on the |
| power | pathloss of the bounced back sensing Tx signal |
| Waveform | Sensing Tx waveform |
| Periodicity | Sensing periodicity interval |
| Sensing duration | Sensing Tx time duration and Rx time duration |
| Directional | Allowed number of beams for sensing sweeping, |
| sensing | allowed beamforming/antenna gain, 3-dB beam |
| | width, etc. |
| Resource | Sensing time/frequency resource configuration |
| | including signal BW and carrier frequency |

The IEs may include maximum transmission power for sensing waveform transmission, target reception power of the reflected sensing waveform for power control, sensing waveform and transmission periodicity, sensing duration, attributes for directional sensing including allowed number of beams and beam width, and sensing resource in time, frequency, and spatial domain, etc.

FIG. 11 illustrates a high level diagram of an example directional sensing via beam sweeping according to various embodiments of this disclosure. The embodiment of FIG. 11 is for illustration only. Other embodiments of the process 1100 could be used without departing from the scope of this disclosure.

FIG. 11 is an example directional sensing via beam sweeping. Directional sensing can be beneficial for longer sensing range and acquisition of directional object detection for a plurality of objects object 1 1101, object 2 1102, and object 3 1103. In one embodiment, directional sensing can be performed via analog beam sweeping, e.g., via DFT beam steering, digital beam sweeping, e.g., via codebook cycling, or both. Total number of beams, max/min beam-width, and reception time in-between transmission beam sweeping can be configured.

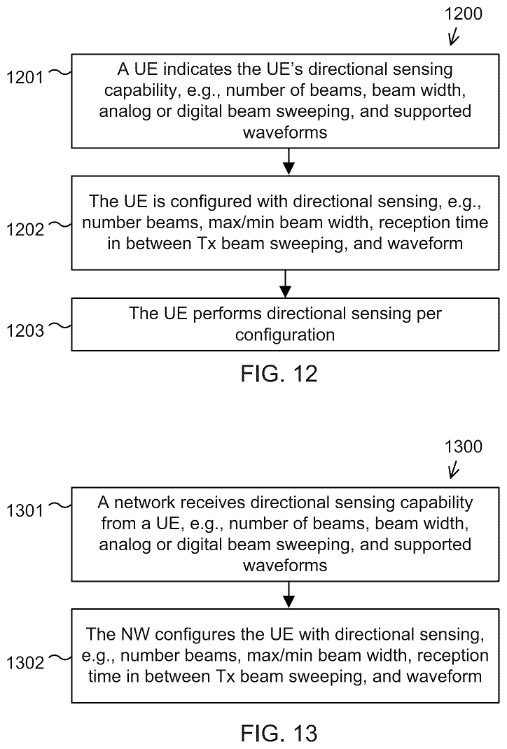

FIG. 12 illustrates a high level flowchart for UE operation of directional sensing according to various embodiments of this disclosure. The embodiment of FIG. 12 is for illustration only. Other embodiments of the process 1200 could be used without departing from the scope of this disclosure.

FIG. 12 is an example of a method 1200 for directional sensing from a UE perspective consistent with other embodiments disclosed herein. At 1201, in addition to general sensing capability indication listed in TABLE 1, the UE indicates the UE's capability related to directional sensing, such as beam-width, analog/digital beam sweeping capability, directional granularity, horizontal/vertical sweeping capability, sensing mode (e.g., bi-static/mono-static), etc. associated with directional sensing, etc. At 1202, the UE is configured by the NW on directional sensing related parameters such as number of beams for sweeping, maximum/minimum allowed beam-width, allowed or restricted beam directions, reception time between beam sweeping if monostatic sensing is configured. At 1203, the UE performs directional sensing as configured.

FIG. 13 illustrates a high level flowchart for NW operation of directional sensing according to various embodiments of this disclosure. The embodiment of FIG. 13 is for illustration only. Other embodiments of the process 1300 could be used without departing from the scope of this disclosure.

FIG. 13 is an example of a method 1300 for directional sensing from a NW perspective consistent with embodiments disclosed herein. At 1301, in addition to general sensing capability indication listed in TABLE 1, the NW receives an indication of the UE's capability related to directional sensing, such as beam-width, analog/digital beam sweeping capability, directional granularity, horizontal/vertical sweeping capability, sensing mode (e.g., bi-static/mono-static), etc. associated with directional sensing, etc. At 1302, the NW configures the UE on directional sensing related parameters such as number of beams for sweeping, maximum/minimum allowed beam-width, allowed or restricted beam directions, reception time between beam sweeping if monostatic sensing is configured.

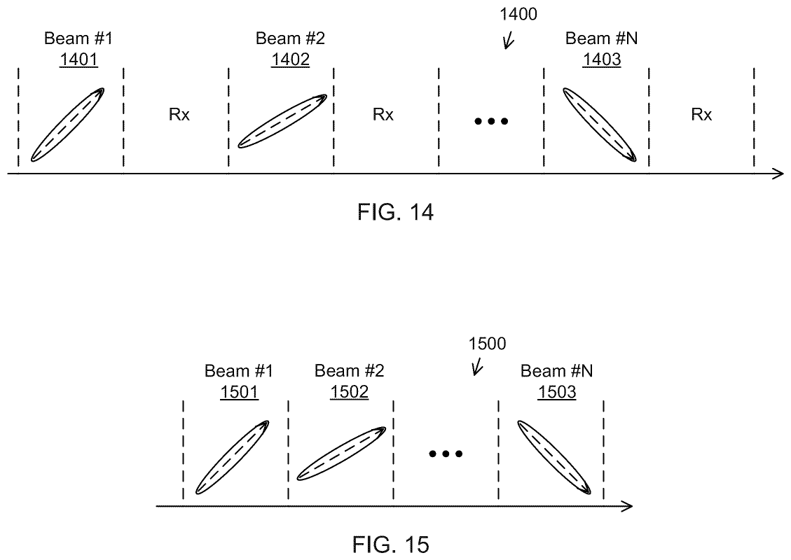

FIG. 14 illustrates an example of monostatic directional sensing operation according to various embodiments of this disclosure. The embodiment of FIG. 14 is for illustration only. Other embodiments of the operation 1400 could be used without departing from the scope of this disclosure.

FIG. 14 is an example monostatic directional sensing operation, in which the UE transmits sensing signal as well as receives the returning sensing signal. The UE is configured with a number of directional sensing signal transmissions (beam #1 1401, beam #2 1402, through beam #N 1403) and gaps for the reception of returning sensing signal. In one embodiment, the unit of time for sensing signal transmission and reception is a symbol, a slot, or any predefined time duration.

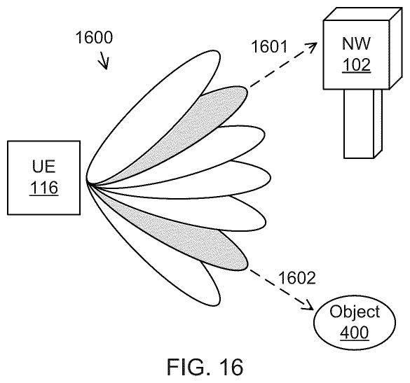

FIG. 15 illustrates an example of bi-static directional sensing operation from transmitter perspective according to various embodiments of this disclosure. The embodiment of FIG. 15 is for illustration only. Other embodiments of the operation 1500 could be used without departing from the scope of this disclosure.

FIG. 15 is an example bi-static directional sensing operation, in which one device transmits the sensing signals and another device receives the sensing signal. In FIG. 15, the transmitter performs beam sweeping (beam #1 1501, beam #2 1502, through beam #N 1503) for directional sensing.

In one embodiment, a UE transmits a signal for communication and a signal for sensing simultaneously via spatial multiplexing.

FIG. 16 illustrates an example of spatial multiplexing of communication and sensing signal according to various embodiments of this disclosure. The embodiment of FIG. 16 is for illustration only. Other embodiments of the configuration 1600 could be used without departing from the scope of this disclosure.

FIG. 16 is an example of a spatial multiplexing operation in which the UE selects a direction for sensing signal transmission orthogonal or near-orthogonal to the direction for UL signal transmission to a BS. In one embodiment, the UE makes decision on whether to perform spatial multiplexing of a signal for communication 1601 and a signal for sensing 1602, and selects the direction for the sensing signal 1602 transmission based on orthogonality to the direction of communication signal 1601 transmission. There can be a threshold value for the orthogonality measurement for making such decision, i.e., not necessarily perfectly orthogonal. In one embodiment, the UE informs the BS of the sensing signal, e.g., type of reference signal or sequences, etc., and the beamforming vector used for sensing signal transmission, so that the BS may optionally perform cancelation of interference due to sensing signal at the BS before decoding UL signal received from the UE.

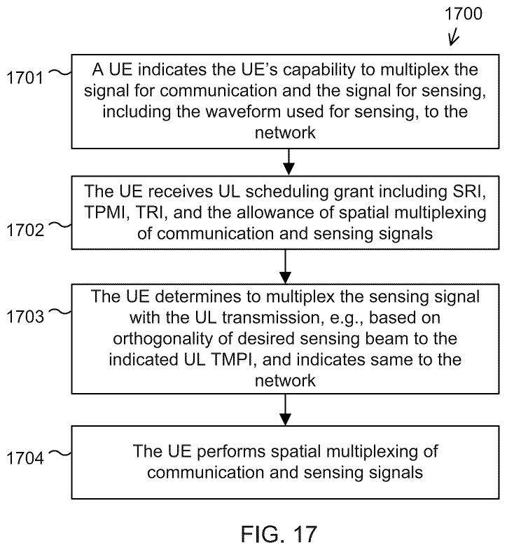

FIG. 17 illustrates a high level flowchart for UE operation of spatial multiplexing of communication and sensing signal according to various embodiments of this disclosure. The embodiment of FIG. 17 is for illustration only. Other embodiments of the process 1700 could be used without departing from the scope of this disclosure.

FIG. 17 is an example of a method 1700 for spatial multiplexing of communication and sensing signals from a UE perspective consistent with other embodiments disclosed herein. At 1701, a UE indicates to the NW whether the UE has capability for spatial multiplexing of communication and sensing signals and the waveform used for sensing signals. At 1702, the UE receives UL scheduling grant along with SRI, transmitted precoding matric indicator (TPMI), or CSI-RS Resource Indicator (CRI), from which the UE can infer the UL signal transmission direction. The UE also receives an indication of whether spatial multiplexing of communication and sensing signals is allowed. At 1703, the UE determines whether to perform spatial multiplexing of communication and sensing signals. This determination can be based on the orthogonality of desired sensing direction to the indicated UL signal transmission direction. At 1704, the UE performs spatial multiplexing of communication and sensing signals.

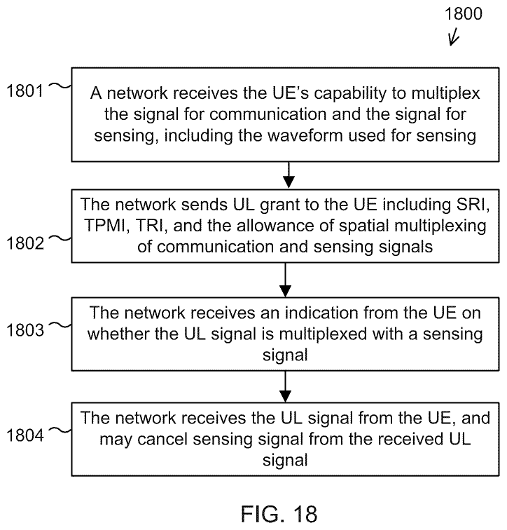

FIG. 18 illustrates a high level flowchart for NW operation of spatial multiplexing of communication and sensing signal according to various embodiments of this disclosure. The embodiment of FIG. 18 is for illustration only. Other embodiments of the process 1800 could be used without departing from the scope of this disclosure.

FIG. 18 is an example of a method 1800 for spatial multiplexing of communication and sensing signals directional sensing from a NW perspective consistent with other embodiments disclosed herein. At 1801, the NW receives from a UE an indication of whether the UE has capability for spatial multiplexing of communication and sensing signals and the waveform used for sensing signals. At 1802, the network sends the UE a UL scheduling grant along with SRI, TPMI, CRI, from which the UE can infer the UL signal transmission direction. The NW also sends an indication of whether spatial multiplexing of communication and sensing signals is allowed. At 1803, the network receives an indication from the UE indicating whether the UL signal is spatially multiplexed with sensing signals. At 1804, the NW can perform cancelation of interference from sensing signal(s) to the UL signal from the UE based on the knowledge of the waveform used for sensing, the precoder used for sensing signal transmission, and the measured channel between the UE and the NW.

Embodiments of the disclosure for supporting joint communication and radar sensing in wireless communication systems are summarized in the following and are fully elaborated further below.
Method and apparatus for sensing interference cancelation at a BS for UL data reception.
Method and apparatus for sensing interference cancelation at a UE for DL data reception.
Method and apparatus for configuring sensing beam restriction for sensing interference suppression at a DL/UL receiver for communication.

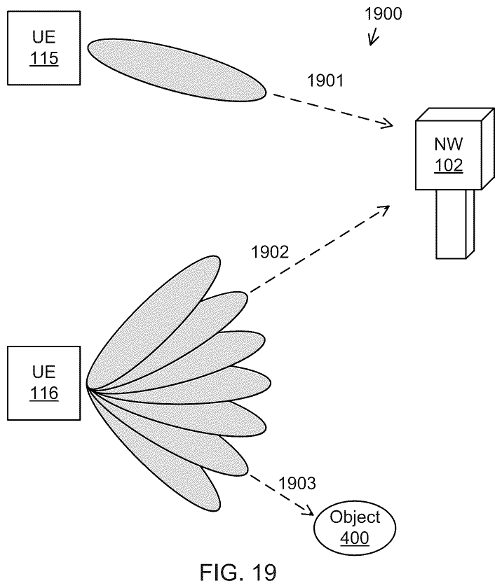

FIG. 19 illustrates an example of sensing interference at a BS for UL data demodulation according to various embodiments of this disclosure. The embodiment of FIG. 19 is for illustration only. Other embodiments of the configuration 1900 could be used without departing from the scope of this disclosure.

FIG. 19 is an example illustration of sensing interference at a BS for UL data demodulation. In the figure, UE 1 115 is transmitting a UL signal 1901 to the BS 102 and UE 2 116 is performing monostatic sensing for object detection using sensing signals 1902, 1903. The embodiments disclosed can be generally applied to other types of sensing operations, such as bi-static sensing. A certain direction of the sensing signal 1902 transmission has a more interference impact at an intended receiver (BS 102) of the UL data communication 1901. In one embodiment, the BS 102 and the UE 116 that is transmitting the sensing signals exchange information on the sensing resource, sensing signal, beamforming vector for sensing signal transmission, and the channel state between the BS and the UE. Then the BS performs sensing interference cancelation for demodulating the signal 1901 for communication.

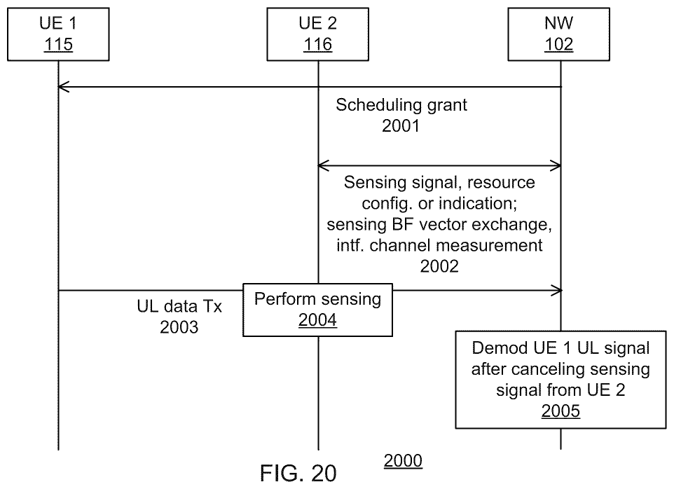

FIG. 20 illustrates a high level diagram of an example procedure for sensing interference cancelation at a BS for UL data demodulation according to various embodiments of this disclosure. The embodiment of FIG. 20 is for illustration only. Other embodiments of signaling could be used without departing from the scope of this disclosure.

FIG. 20 is an example procedure for sensing interference cancelation at a BS 102 for UL data demodulation. The NW schedules UE 1 115 for UL data transmission with scheduling grant 2001, and therefore is aware of the resource to be used for UL data transmission. The NW and the UE that is transmitting sensing signal (i.e., UE 2 116 in this example) exchange information 2002 on the sensing resource, sensing signal, beamforming vector for sensing signal transmission, and the channel state between the BS 102 and the UE 116. The sensing resource, sensing signal, and/or beamforming vector can be configured by the NW 102 to UE 2 116, or the UE 2 116 may decide on those parameters and inform the NW. In order to cancel the sensing interference at the NW 102, the NW 102 also needs to know the interference channel. In one example, the interference channel is measured at the NW 102 from a reference signal, e.g., SRS, transmitted by the UE 116 for communication purpose. In another example, the interference channel is measured at the NW 102 from the sensing signal transmitted by the UE 116. In yet another example, the UE 116 measures the interference channel from a DL reference signal transmitted by the NW 102 and sends feedback on the measured channel back to the NW 102. After such information exchange and coordination 2002, UE 1 115 transmits UL data 2003 and UE 2 116 concurrently performs a sensing operation 2004 on the same or overlapping resources. The received signal at the NW 102 for data reception from UE 1 115 is interfered with by the sensing signal transmitted by UE 2 116. Utilizing the known sensing signal, beamforming vector, and interference channel, the NW 102 performs sensing interference cancelation prior to demodulating 2005 the data from UE 1 115.

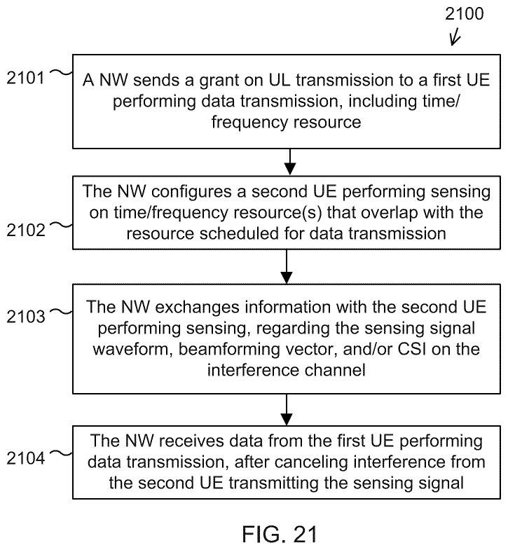

FIG. 21 illustrates a high level flowchart for a NW to perform sensing interference cancelation for UL data reception according to various embodiments of this disclosure. The embodiment of FIG. 21 is for illustration only. Other embodiments of the process 2100 could be used without departing from the scope of this disclosure.

FIG. 21 is an example of a method 2100 for a NW to perform sensing interference cancelation for UL data reception consistent with other embodiments disclosed herein. At 2101, a NW sends a grant on UL transmission to a first UE performing data transmission, including time/frequency resource. At 2102, the NW configures a second UE performing sensing on time/frequency resource(s) that overlap with the resource scheduled for data transmission. At 2103, the NW exchanges information with the second UE performing sensing, regarding the sensing signal waveform, beamforming vector, and/or CSI on the interference channel. At 2104, the NW receives data from the first UE performing data transmission, after canceling interference from the second UE transmitting the sensing signal.

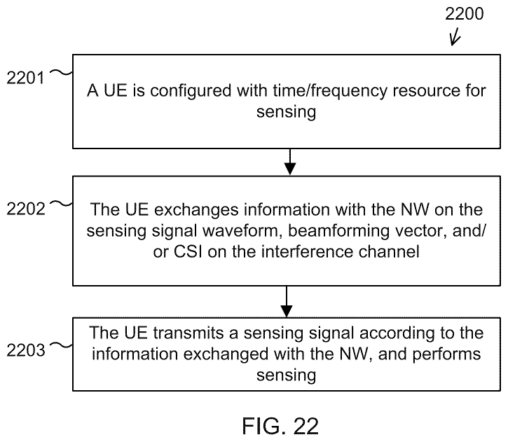

FIG. 22 illustrates a high level flowchart for a UE performing sensing and assisting NW for sensing interference cancelation according to various embodiments of this disclosure. The embodiment of FIG. 22 is for illustration only. Other embodiments of the process 2200 could be used without departing from the scope of this disclosure.

FIG. 22 is an example of a method 2200 for UE performing sensing and assisting NW for sensing interference cancelation consistent with other embodiments disclosed herein. At 2201, a UE is configured with a time/frequency resource for sensing. At 2202, the UE exchanges information with the NW regarding the sensing signal waveform, beamforming vector, and/or CSI on the interference channel. At 2203, the UE transmits a sensing signal according to the information exchanged with the NW, and performs sensing.

Notably, the operation of a UE transmitting date (i.e., UE 1 115 in FIG. 19) is omitted, since the behavior is no different than a legacy UE transmitting UL data.

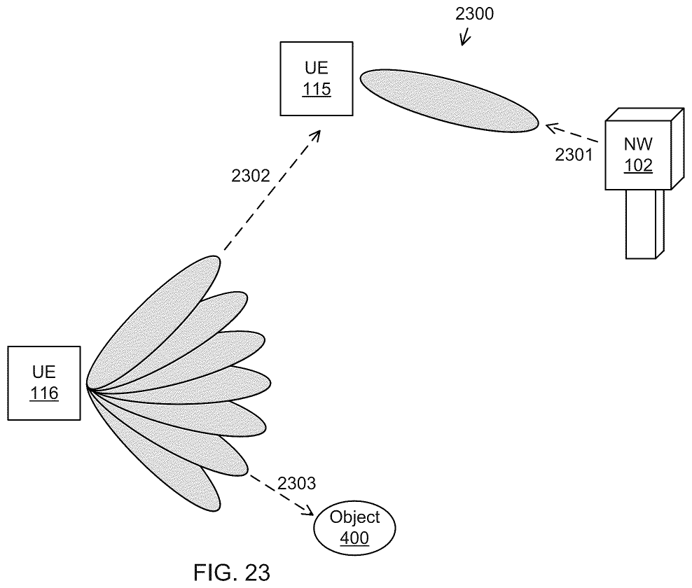

FIG. 23 illustrates an example of sensing interference at a UE for DL data demodulation according to various embodiments of this disclosure. The embodiment of FIG. 23 is for illustration only. Other embodiments of the configuration 2300 could be used without departing from the scope of this disclosure.

FIG. 23 is an example illustration of sensing interference at a UE for DL data demodulation. In the example shown, UE 1 115 is receiving a DL signal 2301 from the BS 102 and UE 2 116 is performing monostatic sensing for object detection using sensing signals 2302, 2303. The embodiments disclosed can be generally applied to other types of sensing operations, such as bi-static sensing. Certain direction(s) of sensing signal transmission have a more interference impact at an intended receiver of the DL data communication (which is UE 115). In one embodiment, the BS 102 and the UE transmitting sensing signal (i.e., UE 2 116) exchange information on the sensing resource, sensing signal, and beamforming vector for sensing signal transmission, which are then transmitted to the UE receiving DL data (i.e., UE 1 115) to assist the sensing interference cancelation for demodulating the DL signal from the NW 102. In another example, the UE transmitting sensing signal (i.e., UE 2 116) and the UE receiving DL data (i.e., UE 1 115) can directly communicate with each other to exchange information on the sensing resource, sensing signal, and beamforming vector for sensing signal transmission over sidelink channels such Physical Sidelink Broadcast Channel (PSBCH), Physical Sidelink Control Channel (PSCCH), Physical Sidelink Shared Channel (PSSCH), Physical Sidelink Feedback Channel (PSFCH). Information on the sensing resource, sensing signal, and beamforming vector for sensing signal transmission can be part of Sidelink Channel Information (SCI) and/or Sidelink Feedback Control Information (SFCI). Based on these information, UE 1 115 performs sensing interference cancelation for demodulating signal for communication.

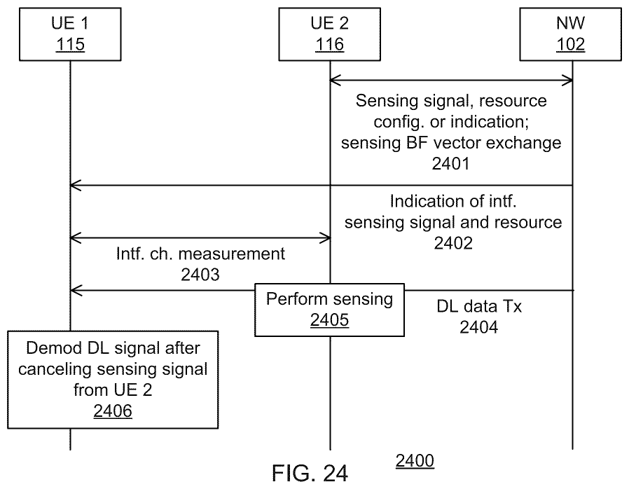

FIG. 24 illustrates a high level diagram of an example procedure for sensing interference cancelation at a UE for DL data demodulation according to various embodiments of this disclosure. The embodiment of FIG. 24 is for illustration only. Other embodiments of signaling could be used without departing from the scope of this disclosure.

FIG. 24 is an example procedure for sensing interference cancelation at a UE for DL data demodulation. In one embodiment, the NW 102 and the UE transmitting sensing signal (i.e., UE 2 116 in the example shown) exchange 2401 information on the sensing resource, sensing signal, and beamforming vector for sensing signal transmission. This information is sent 2402 by the NW 102 to the UE receiving DL data (UE 1 115 in the example shown). In another embodiment, the UE transmitting sensing signal (UE 2 116), and the UE receiving DL data (UE 1 115) can directly communicate with each other to exchange information on the sensing resource, sensing signal, and beamforming vector for sensing signal transmission over sidelink channels as exemplified. The sensing resource, sensing signal, and/or beamforming vector can be configured by the NW 102 to UE 2 116, or the UE 2 116 may decide by itself and inform the NW 102. In order to cancel the sensing interference at UE 1 115, UE 1 115 also needs to know the interference channel. In one embodiment, the NW 102 configures RS, such as Sidelink Primary Synchronization Signal (SPSS) or Sidelink Secondary Synchronization Signal (SSSS) over the sidelink between UE 1 115 and UE 2 116 so that UE 2 116 transmits RS and the UE 1 115 measures 2403 the interference channel. In another embodiment, UE 1 115 measures 2403 interference channel from sensing signal transmitted by UE 2 116. For this, UE 2 116 informs the sensing signal waveform, transmission power, and/or timing and frequency resource over which the transmission is occurring. In yet another embodiment, the UE 2 116 can overhear RSs transmitted by UE 1 115 for ordinary communication purpose, measures the channel, and feeds back to UE 1 115 over sidelink channels. After such information exchange and coordination, NW 102 transmits 2404 DL data and UE 2 116 performs 2405 sensing operation on the same or overlapping resource. The received signal at the UE 1 115 for data reception from NW 115 is interfered by the sensing signal transmitted by UE 2. Utilizing the known sensing signal, beamforming vector, and interference channel, the UE performs 2406 sensing interference cancelation prior to demodulating the data from NW.

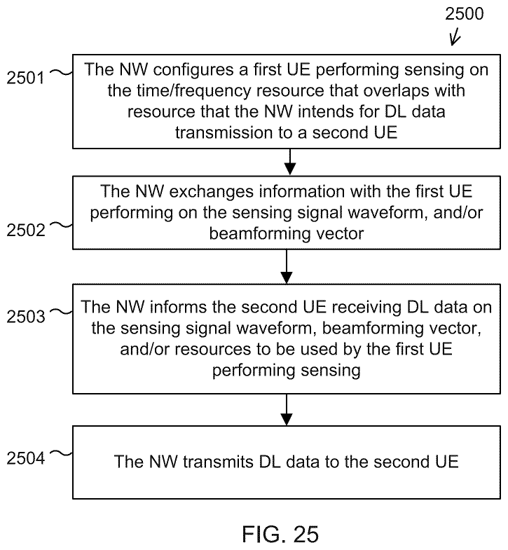

FIG. 25 illustrates an example of a NW to assist sensing interference cancelation at a UE for DL data reception according to various embodiments of this disclosure. The embodiment of FIG. 25 is for illustration only. Other embodiments of the process 2500 could be used without departing from the scope of this disclosure.

FIG. 25 is an example of a method 2500 for NW to assist sensing interference cancelation for DL data reception at a UE consistent with other embodiments disclosed herein. At 2501, the NW configures a first UE performing sensing on the time/frequency resource that overlaps with resource that the NW intends for DL data transmission to a second UE. At 2502, the NW exchanges information with the first UE performing on the sensing signal waveform, and/or beamforming vector. At 2503, the NW informs the second UE receiving DL data on the sensing signal waveform, beamforming vector, and/or resources to be used by the first UE performing sensing. At 2504, the NW transmits DL data to the second UE. As described earlier, 2502 and 2503 can be replaced by direct communication between the first and the second UEs over a sidelink.

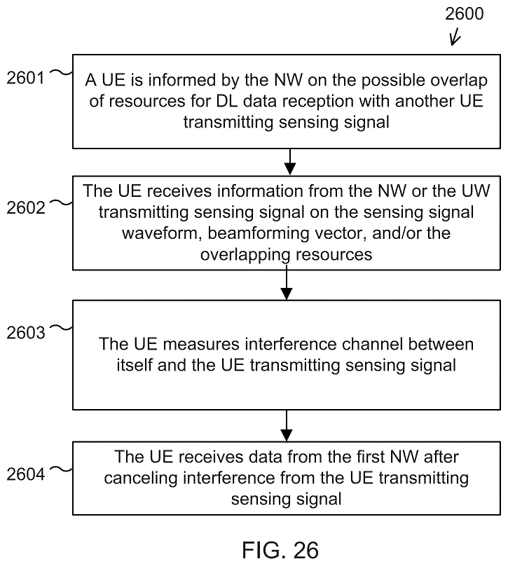

FIG. 26 illustrates an example of a UE receiving DL data with sensing interference cancelation according to various embodiments of this disclosure. The embodiment of FIG. 26 is for illustration only. Other embodiments of the process 2600 could be used without departing from the scope of this disclosure.

FIG. 26 is an example of a method 2600 for UE receiving DL data with sensing interference cancelation consistent with other embodiments disclosed herein. At 2601, a UE is informed by the NW on the possible overlap of resources for DL data reception with another UE transmitting sensing signal. At 2602, the UE receives information from the NW or the UW transmitting sensing signal on the sensing signal waveform, beamforming vector, and/or the overlapping resources. At 2603, the UE measures the interference channel between itself and the UE transmitting sensing signal. At 2604, the UE receives data from the first NW after canceling interference from the UE transmitting sensing signal. As described earlier, 2602 can be replaced by direct communication between the first and the second UEs over sidelink.

Notably, the operation of a UE performing sensing (i.e., UE 2 116 in FIG. 23) is omitted, since the behavior is no different from that illustrated in FIG. 22.

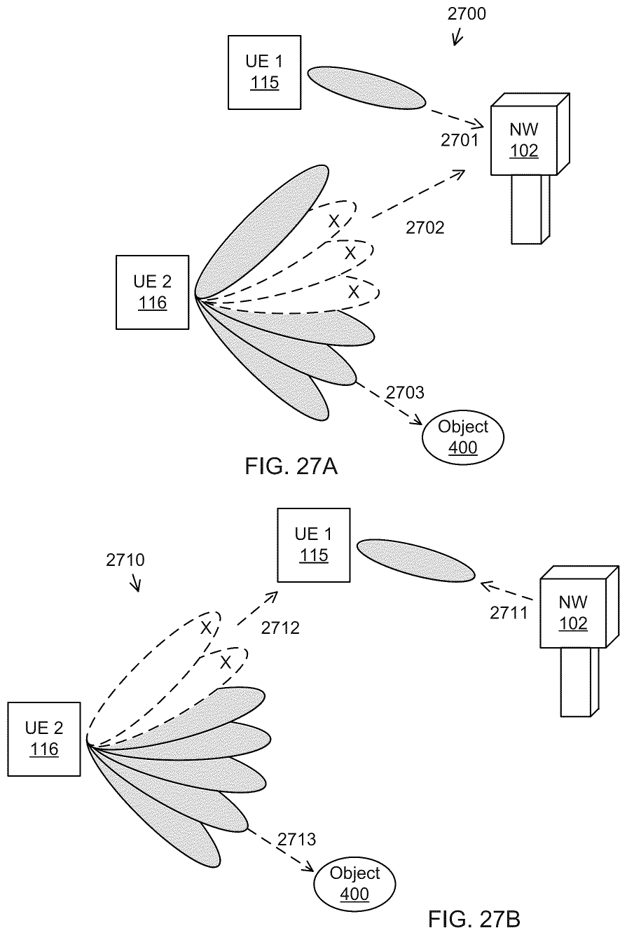

FIGS. 27A and 27B illustrate examples of sensing beam restriction according to various embodiments of this disclosure. The embodiments of FIGS. 27A and 27B are for illustration only. Other embodiments of the configurations 2700, 2710 could be used without departing from the scope of this disclosure.

FIGS. 27A and 27B are examples illustrating of sensing beam restriction to suppress sensing interference at an intended receiver for data communication. FIG. 27A depicts the situation in which the sensing signal 2702, 2703 transmitted by UE 2 116 interferes with the UL data transmission 2701 by UE 1 115, which is received at the BS 102. Therefore, in one embodiment, the sensing beams are restricted from the BS perspective to restrict strong interfering beam directions from sensing UEs for the BS's UL data reception. FIG. 27B depicts the situation in which the sensing signal 2712, 2713 transmitted by UE 2 116 interferes with the DL data transmission 2711 by the BS 102, which is received at the UE 1 115. Therefore, in another embodiment, the sensing beams are restricted from the perspective of a UE receiving DL data to restrict strong interfering beam directions from sensing UEs for the sensing UE's DL data reception. The interfering sensing beam directions can be identified during legacy beam measurement and management procedure for communication between the BS and the sensing UE.

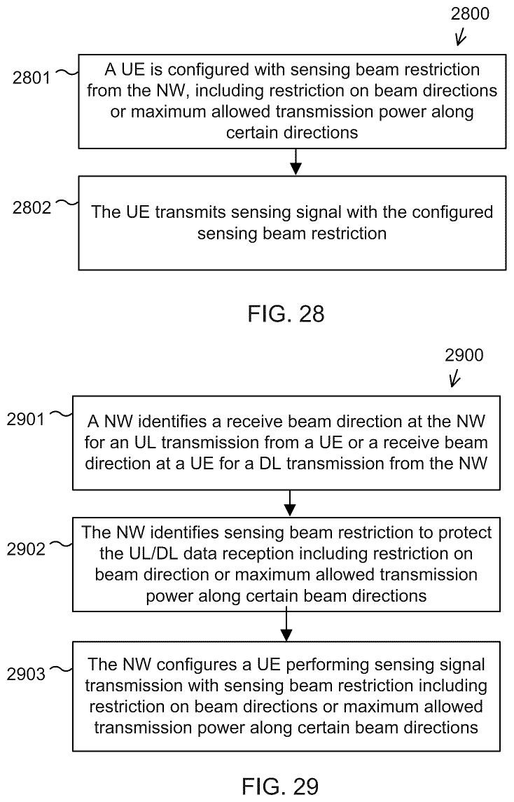

FIG. 28 illustrates an example of a UE transmitting sensing signal(s) with beam restriction according to various embodiments of this disclosure. The embodiment of FIG. 28 is for illustration only. Other embodiments of the process 2800 could be used without departing from the scope of this disclosure.

FIG. 28 is an example of a method 2800 for UE r transmitting sensing signal(s) with beam restriction consistent with other embodiments disclosed herein. At 2801, a UE is configured with sensing beam restriction. In one embodiment, the sensing beam restriction is indicated as the list of prohibited codebook indices, prohibited vertical and/or horizontal angular ranges, or as beam indices aligned between the UE and the network. In another embodiment, the sensing beam restriction is indicated as the maximum allowed transmission power, antenna gain, or EIRP, which may or may not be associated with certain beam directions. The UE is also configured with time domain pattern and/or frequency resources for which the restriction is applied. In one example, the sensing beam restriction can be configured to the UE via L1/L2, MAC-CE, RRC or any higher layer signaling. In one embodiment, the configured sensing beam restriction can be activated or deactivated via L1/L2, MAC-CE, RRC or any higher layer signaling. At 2802, the UE transmits sensing signal with the configured sensing beam restriction.

FIG. 29 illustrates an example for NW to configure sensing beam restriction to a UE transmitting sensing signal according to various embodiments of this disclosure. The embodiment of FIG. 29 is for illustration only. Other embodiments of the process 2900 could be used without departing from the scope of this disclosure.

FIG. 29 is an example of a method 2900 for NW to configure sensing beam restriction to a UE transmitting sensing signal consistent with other embodiments disclosed herein. This flowchart includes both UL/DL data transmission scenarios depicted in FIGS. 27A-27B. At 2901, a NW identifies a receive beam direction at the NW for an UL transmission from a UE or a receive beam direction at a UE for a DL transmission from the NW. At 2902, the NW identifies sensing beam restriction to protect the UL/DL data reception including restriction on beam direction or maximum allowed transmission power along certain beam directions. At 2903, the NW configures a UE performing sensing signal transmission with sensing beam restriction including restriction on beam directions or maximum allowed transmission power along certain beam directions.

For illustrative purposes the steps of algorithms above are described serially. However, some of these steps may be performed in parallel to each other. The operation diagrams illustrate example methods that can be implemented in accordance with the principles of the present disclosure and various changes could be made to the methods illustrated in the flowcharts. For example, while shown as a series of steps, various steps in each figure could overlap, occur in parallel, occur in a different order, or occur multiple times. In another example, steps may be omitted or replaced by other steps.

Although this disclosure has been described with an exemplary embodiment, various changes and modifications may be suggested to one skilled in the art. It is intended that this disclosure encompass such changes and modifications as fall within the scope of the appended claims.

What is claimed is:

1. A method, comprising:
indicating, by a user equipment (UE), the UE's directional sensing capability including number of beams, beam-width, analog or digital beam sweeping, and supported waveforms;
receiving, at the UE, a configuration for directional sensing including number of beams, maximum or minimum beam-width, reception time between transmission beam sweeping, and waveform;
performing, by the UE, directional sensing based on the received configuration.

2. The method of claim 1, wherein the configuration for directional sensing is for one of monostatic sensing with reception periods between consecutive sensing signal transmissions or bistatic sensing using a plurality of beams.

3. The method of claim 1, wherein the UE's directional sensing capability includes capability of spatial multiplexing of sensing signals with communication signals, and wherein the configuration for directional sensing enables spatial multiplexing of sensing signals with communication signals, the method further comprising:
determining, by the UE, to perform spatial multiplexing of sensing signals with communication signals based on orthogonality of a desired sensing beam with a beam for communications.

4. The method of claim 1, further comprising:
exchanging, by the UE with a base station, information on a sensing signal waveform, sensing signal beamforming vector, and channel state information on an interference channel for use by the base station in performing sensing signal interference cancelation with uplink data communications signals from another UE.

5. The method of claim 1, further comprising:
receiving, at the UE, an indication of overlap of resources for downlink data reception by the UE and resources for directional sensing by another UE; and
receiving, at the UE, information relating to sensing signal waveform and beamforming vector used by the other UE;
measuring an interference channel between the UE and the other UE; and
receiving downlink data after performing interference cancelation based on the measured interference channel.

6. The method of claim 1, wherein:
the configuration for directional sensing indicates a restricted beam,
a restriction on the restricted beam comprises one of use of the restricted beam for sensing, maximum sensing transmission power, or target sensing reception power, and
the restriction corresponds to one of a time pattern, frequency resources, or a trigger for the restriction.

7. A user equipment (UE), comprising:
a transceiver configured to
indicate the UE's directional sensing capability including number of beams, beam-width, analog or digital beam sweeping, and supported waveforms, and
receive a configuration for directional sensing including number of beams, maximum or minimum beam-width, reception time between transmission beam sweeping, and waveform; and
a processor operably coupled to the transceiver and configured to perform directional sensing based on the received configuration.

8. The UE of claim 7, wherein the configuration for directional sensing is for one of monostatic sensing with reception periods between consecutive sensing signal transmissions or bistatic sensing using a plurality of beams.

9. The UE of claim 7, wherein the UE's directional sensing capability includes capability of spatial multiplexing of sensing signals with communication signals, and wherein the configuration for directional sensing enables spatial multiplexing of sensing signals with communication signals, the processor further configured to:
determine to perform spatial multiplexing of sensing signals with communication signals based on orthogonality of a desired sensing beam with a beam for communications.

10. The UE of claim 7, wherein the UE is configured to exchange, with a base station, information on a sensing signal waveform, sensing signal beamforming vector, and channel state information on an interference channel for use by the base station in performing sensing signal interference cancelation with uplink data communications signals from another UE.

11. The UE of claim 7, wherein the transceiver is configured to
receive an indication of overlap of resources for downlink data reception by the UE and resources for directional sensing by another UE; and
receive information relating to sensing signal waveform and beamforming vector used by the other UE,
wherein the processor is configured to measure an interference channel between the UE and the other UE, and
wherein downlink data is received after performing interference cancelation based on the measured interference channel.

12. The UE of claim 7, wherein:
the configuration for directional sensing indicates a restricted beam,
a restriction on the restricted beam comprises one of use of the restricted beam for sensing, maximum sensing transmission power, or target sensing reception power, and
the restriction corresponds to one of a time pattern, frequency resources, or a trigger for the restriction.

13. A base station (BS), comprising:
a transceiver configured to
receive, from a user equipment (UE), an indication of the UE's directional sensing capability including number of beams, beam-width, analog or digital beam sweeping, and supported waveforms, and
transmit a configuration for directional sensing including number of beams, maximum or minimum beam-width, reception time between transmission beam sweeping, and waveform,
wherein directional sensing is performed based on the received configuration.

14. The BS of claim 13, wherein the configuration for directional sensing is for one of monostatic sensing with reception periods between consecutive sensing signal transmissions or bistatic sensing using a plurality of beams.

15. The BS of claim 13, wherein the UE's directional sensing capability includes capability of spatial multiplexing of sensing signals with communication signals, and wherein the configuration for directional sensing enables spatial multiplexing of sensing signals with communication signals, wherein spatial multiplexing of sensing signals with communication signals is performed based on orthogonality of a desired sensing beam with a beam for communications.

16. The BS of claim 13, wherein the BS is configured to exchange, with the UE, information on a sensing signal waveform, sensing signal beamforming vector, and channel state information on an interference channel for use by the base station in performing sensing signal interference cancelation with uplink data communications signals from another UE.

17. The BS of claim 13, wherein the transceiver is configured to
transmit an indication of overlap of resources for downlink data reception by the UE and resources for directional sensing by another UE; and
transmit information relating to sensing signal waveform and beamforming vector used by the other UE,
wherein an interference channel between the UE and the other UE is measured, and
wherein downlink data is transmitted after performing interference cancelation based on the measured interference channel.

18. The BS of claim 13, wherein:
the configuration for directional sensing indicates a restricted beam,
a restriction on the restricted beam comprises one of use of the restricted beam for sensing, maximum sensing transmission power, or target sensing reception power, and
the restriction corresponds to one of a time pattern, frequency resources, or a trigger for the restriction.
